(19) United States
(12) Patent Application Publication
(10) Pub. No.: US 2018/0079660 A1
(43) Pub. Date: Mar. 22, 2018

(54) PROCESS AND MATERIAL FOR REMOVAL OF NITROSAMINES FROM AQUEOUS SYSTEMS

(71) Applicant: University of Kentucky Research Foundation, Lexington, KY (US)

(72) Inventors: Leland R. Widger, Lexington, KY (US); Megan L. Combs, Lexington, KY (US); Jesse G. Thompson, Lexington, KY (US); Cameron A. Lippert, Lexington, KY (US); Kunlei Liu, Lexington, KY (US)

(21) Appl. No.: 15/708,844

(22) Filed: Sep. 19, 2017

Related U.S. Application Data
(60) Provisional application No. 62/397,149, filed on Sep. 20, 2016.

(51) Int. Cl. C02F 1/28; B01D 15/00

(52) U.S. Cl. CPC C02F 1/283; C02F 2101/38; B01D 15/00

(57) ABSTRACT

The present invention relates to a method and system for removing nitrosamines from amine-based carbon capture systems by circulating waterwash through a filter of activated carbon. Nitrosamine emission control strategies are critical for the success of amine-based carbon capture as the technology approaches industrial-scale deployment. Waterwash systems are used to control volatile and aerosol emissions, including nitrosamines, from carbon capture plants, but it is still necessary to remove or destroy nitrosamines in the circulating waterwash to prevent their subsequent emissions into the environment. The circulation of the water over a sorbent bed of activated carbon provides a cost-effective approach to selectively remove nitrosamines from the waterwash effluent to reduce the environmental impact associated with amine-based carbon capture.

### RELATED APPLICATIONS

This application claims priority to U.S. Provisional Patent Application 62/397,149, filed Sep. 20, 2016, all of which is hereby incorporated by reference in its entirety.

### FIELD OF THE INVENTION

The present invention relates to a process for active and continuous removal of volatile nitrosamines that accumulate in the waterwash section of a carbon capture system (CCS) before they can be emitted into the atmosphere.

### BACKGROUND

Widespread legislation requiring the capture of greenhouse gas emissions from major industries, including fossil fuel power generation, makes the implementation of commercial carbon capture systems (CCS) imminent. Among the various capture approaches, amine-based post-combustion CCS is currently the most promising option for separating CO₂ from industry flue gases due to its relatively simple operation, high absorption capacity, and technological maturity.

However, there are still cost and safety concerns that are slowing widespread implementation of this technology. The possibility of forming highly carcinogenic nitrosamines within the CCS process, and their subsequent emission into the environment, is arguably one of the critical concerns for regulators and communities near proposed CCS projects. Nitrosamines are volatile products known to form from amines, particularly secondary amines or secondary amine containing degradation products, and NOx oxidants that are common flue gas contaminants.

Nitrosamines have been detected from amine waterwash sections up to 59 μM [Dai et al., 2012] and in emissions up to 47 ng/Nm³ [da Silva et al., 2013]. Despite favorable conditions for nitrosamine formation and the ease of emission from the solvent, the detection of even low levels of nitrosamines can lead to the delay of a CCS project. Nitrosamines currently represent one of the last technical challenges amine-based CCS is facing.

Significant research effort has been directed toward the understanding, detection, isolation, capture, and destruction of nitrosamines. Several research groups have proposed nitrosamine destruction strategies, including catalytic hydrogenation in the presence of excess H₂ at elevated pressure and temperature, photo- and electrochemical reduction with expensive catalysts, and the capture of nitrosamines using expensive and unstable zeolite membranes (Chandan et al., Int. J. Greenhouse Gas Control 2014, 31, 61-66; Sun et al., Microporous and Mesoporous Materials 2014, 200, 260-268; Li et al., Environmental Chemistry Letters 2014, 12 (1), 139-152, Chandan et al., Int. J. Greenhouse Gas Control 2015, 39, 158-165; Chon et al., Bioresource Technology 2015, 190, 499-507; Dai and Mitch, Environ. Sci. Technol. 2015, 49 (14), 8878-8886). The complexity of these methods adding additional cost to the CCS unit has led to the development of a simple and cost effective strategy to utilize well-known materials the industry is familiar with.

The schematic of an amine-based carbon capture process in FIG. 1 depicts an aqueous amine solvent circulated between a CO₂ absorber and stripper. Industry flue gas, rich in CO₂, enters at the bottom of the absorber as amine solvent is sprayed from the top of the absorber. The counter flow of flue gas and solvent across specialized packing promotes the mass transfer and chemical absorption of CO₂ into the solvent. The cleaned acid gas is then passed through the water-wash section before being released into the atmosphere. The CO₂-rich amine solvent is passed through a heat exchanger before being heated in the stripper. The stripper uses heat to liberate CO₂ from the solvent for compression and storage, regenerating the CO₂-lean amine solvent that is returned to the absorber by way of the heat exchanger to repeat the process.

### SUMMARY OF THE INVENTION

The invention relates to a process for removing nitrosamines from the waterwash of a carbon capture system by selective adsorption of nitrosamines from the waterwash section of acid gas purification systems by activated carbon sorbents.

The processes of the invention are designed to capture nitrosamines from waterwash in a carbon capture system (CCS) by establishing an exit portal and an entrance portal to a waterwash chamber of the CCS and providing a circulation connection line between the exit and the entrance portal such that waterwash can flow; placing a sorbent bed within the circulation connection line, wherein the sorbent bed comprises activated carbon; and circulating waterwash from the waterwash section through the sorbent bed and back to the waterwash section to capture nitrosamines.

In some embodiments, activated carbon in the sorbent bed may have an average surface area of between about 600 to 1200 m2/g. In other embodiments, activated carbon in the sorbent bed may have an average pore volume of between about 0.3 and 0.7 cm3/g. Further, activated carbon in the sorbent bed has an average pore size of between about 2.0 and 3.0 nm. Further still, activated carbon in the sorbent bed may have an average mesh size of between 8-10 to 8-30 mesh. The activated carbon may a surface pKa of between about 6.5 to 11.

In some embodiments, the activated carbon in the sorbent bed may include surface oxygen such that surface content of carbon to oxygen is from about 95:5 to about 75:25. In some other embodiments, the activated carbon can further include the presence of at least one of chlorine, potassium, iron, sodium, aluminum, magnesium, phosphorus, iron, silicon, sulfur, calcium or mixtures thereof.

The methods and systems of the invention can also include at least one screen to prevent the sorbent bed from flowing from into the waterwash section. Further optional features include providing a pump connected to the circulation connection line to assist in circulating the waterwash and at least one valve to control the flow of waterwash.

The sorbent bed can be regenerated or replaced to provide continued nitrosamine capture over a prolonged period of time. Regeneration of the sorbent bed be accomplished through thermal treatment of the sorbent bed at between about 700 to 1000° C. Alternatively, the sorbent bed can be replaced altogether or by replacing the solid sorbent in the bed.

The disclosure herein also contemplates a carbon capture system (CCS) of an absorber section, a stripper section, a waterwash section and a sorbent bed section. The waterwash section is connected to the sorbent bed section such that water can circulate from the waterwash section to the sorbent bed section and return back to the waterwash section The sorbent bed is comprised of a solid sorbent to selectively remove or trap nitrosamines from the circulating waterwash.

### BRIEF DESCRIPTION OF THE DRAWINGS

FIG. 1 shows a generalized schematic of CO₂ capture process using aqueous amine solvent and thermal swing regeneration.

FIG. 2 shows adsorption of nitrosopyrrolidine (NPy), nitrosomorpholine (NMOR), and nitrosodiethylamine (NDEA) by different activated carbon sources and mesh sizes.

FIG. 3 shows batch mode saturation studies with commercial and oven oxidized 8-12 mesh coconut charcoal activated carbon.

FIG. 4 shows the effect of amine contamination in waterwash section on nitrosopyrrolidine adsorption.

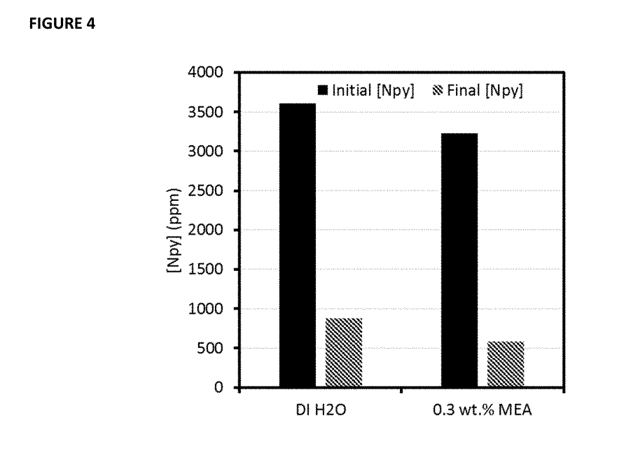

FIG. 5 shows a schematic of circulating sorbent bed apparatus.

FIG. 6 shows SEM images of activated carbon sorbents tested in this study. (a=commercial coconut charcoal, b=oxidized coconut charcoal, c=acid coconut charcoal, d=commercial activated carbon, e=oxidized activated carbon).

FIG. 7 shows adsorption behavior and maximum capacity of NPY (Langumir fit=solid line; Freundlich fit=dotted line) by surface-modified carbon sorbents from a simulated waterwash solution (0.3 wt. % MEA). •=commercial coconut charcoal; ▪=oxidized coconut charcoal; ♦=commercial activated carbon; ▴=oxidized activated carbon; •=acid coconut charcoal.

FIG. 8 shows the effect of NPY concentration on removal efficiency from simulated waterwash solution (0.3 wt. % MEA). •=commercial coconut charcoal; ▪=oxidized coconut charcoal; ♦=commercial activated carbon; ▴=oxidized activated carbon; •=acid coconut charcoal.

FIG. 9 shows the relationship between sorbent surface properties and NPY capacity. (•=commercial coconut charcoal; ▪=oxidized coconut charcoal; ♦=commercial activated carbon; ▴=oxidized commercial activated carbon; •=acid coconut charcoal).

FIG. 10 shows the adsorption of MEA (mg MEA/g carbon) by commercial and modified sorbents from a simulated waterwash solution containing 0.3 wt. % MEA.

FIG. 11 shows the removal of NPY and NPZ nitrosamines (%), with and without amine present in simulated wash-water solutions (MEA with NPY; PZ with NPZ).

FIG. 12 shows the relative capacity of commercial coconut charcoal for NPY, NDEA, and NDELA, from simulated MEA waterwash, and NPZ from simulated PZ waterwash, normalized to adsorption of NPY.

FIG. 13 shows the adsorption of NPY at two different concentrations from a simulated waterwash solution (containing 0.3 wt. % MEA) by commercial coconut charcoal carbon, before (blue) and after (red) thermal regeneration for 20 hours at 200° C.

FIG. 14 shows the effect of extended circulation time on NPY absorption.

FIG. 15 shows a pH of representative model waterwash solutions.

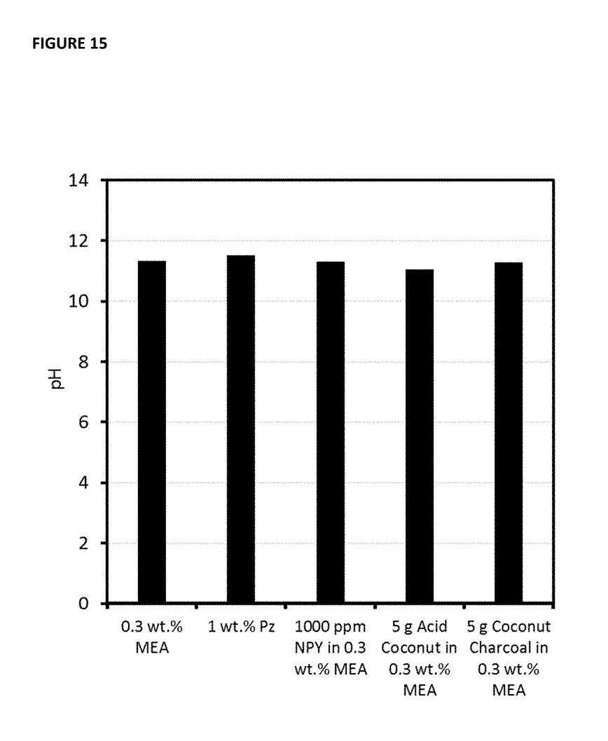

FIG. 16 shows representative replicate experiments for nitrosamine absorption.

FIG. 17 shows the correlation between surface pKₐ and MEA adsorption.

### DETAILED DESCRIPTION

Overall Process

The herein describes a method to address amine pollution that can form and/or escape from waterwash in current amine-based carbon capture systems (CCS). Waterwash systems can assist in capturing nitrosamines from the absorber in a CCS, but waterwash does not destroy or permanently capture them. The incidental release of secondary amines, such as piperazine and nitrosopiperazine from current waterwash pose a serious environmental threat.

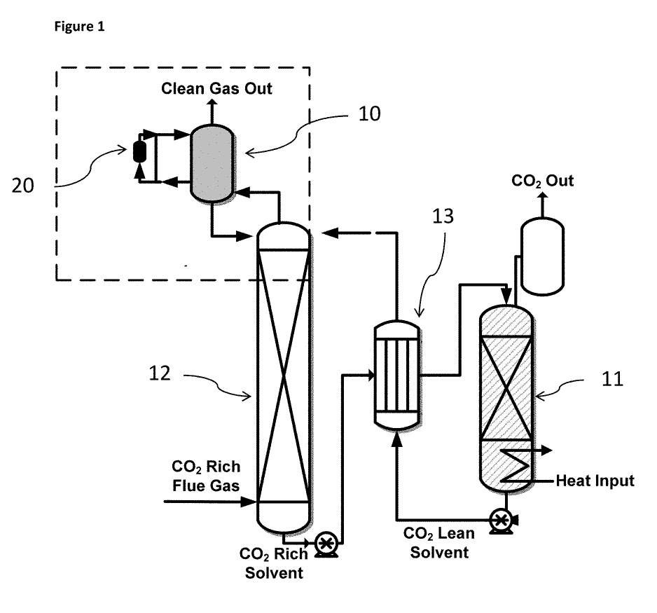

The invention is a system and method to effectively, actively, and continuously remove volatile nitrosamines that accumulate in the waterwash section of a CCS before they can be emitted into the atmosphere. As shown in FIG. 1, a recirculating waterwash section 10 is located above the absorber 12 that is connected to a lean-rich exchanger 13 and a stripper 11. The installation of a slipstream from the waterwash is passed through a sorbent bed 20 comprised of solid sorbents, such as commercial or functionalized activated carbons, zeolites, metal-organic frameworks (MOFs), or polymer-based sorbents, that are an adsorbent selective for nitrosamines that allows for continual nitrosamine scavenging with minimal additional capital or operational costs. The use of abundant, inexpensive, and non-toxic activated carbon for the removal of nitrosamines from the CCS process represents a significant advantage over previously proposed technologies that require expensive materials or catalysts, and possibly hazardous stoichiometric reducing agents such as H₂. Adsorption of the nitrosamine compounds onto a solid sorbent will make handling, transport, and decomposition of the nitrosamines immobilized on the spent filtration material much easier, safer, and cost-effective.

The sorbent bed ideally can be retained in place through the use of a mesh or screen that allows waterwash to flow through, but has pores small enough to prevent solid sorbents from flowing from the sorbent bed. The size of the screen may depend on the size of the solid sorbent.

The sorbent bed is comprised of solid sorbent particles that selectively capture nitrosamines. In some embodiments, the solid sorbent comprises activated carbon particles. The particle size of the activated carbon can range from nano to 3-25 mesh to 50-200 mesh and to 8-12 mesh. Those skilled in the art will appreciate that size selection can affect flow rates and/or pressure within the circulating waterwash. For example, larger particles allow for better flow but might need a larger reactor to function effectively, while smaller particles may be capable of trapping more nitrosamines in a smaller space, but may experience slower flow. Mixtures of different sized particles or partitioned sections within the sorbent bed of different sized articles (e.g. separated by a further screen) provide additional approaches to allow for the waterwash to flow effectively. Similarly, multiple sorbent beds can be arranged in series or parallel to receive the flow of waterwash.

Sources for activated carbon can vary, such as from coconut charcoal and other carbonaceous materials, such as bamboo, coconut husk, willow peat, wood, coir, lignite, coal, and petroleum pitch.

Current waterwash technologies are located after the absorber column, and are designed to dissolve droplets, vapors, and aerosols that contain amine solvent and degradation products from being released into the atmosphere. Some potentially dangerous compounds, such as nitrosamines, have high vapor pressure and are very likely to be caught in the waterwash section. It is far more advantageous to adsorb the nitrosamine contaminants in the waterwash, where the parent amine concentration is only ^{˜}0.3 wt % than to treat the bulk solvent with a concentration of ^{˜}30 wt %. The waterwash section also has a far smaller volume than the bulk solvent and is used for water makeup in the bulk amine solvent. The novel technology comprises of a selective sorbent bed added to the recirculating waterwash, to remove nitrosamines while leaving residual solvent amine molecules in solution that can return to the absorber. The waterwash solution that captures volatiles from the absorber and recirculates within the waterwash section, includes a pathway for emptying the waterwash into the absorber column for make-up when necessary and will retain any captured solvent amine. Isolation and removal on nitrosamine contaminants in the waterwash section eliminate the need for a separate reactor to reduce nitrosamines with H₂, treat the entire bulk solvent, or dispose of the solvent or waterwash as hazardous waste due to nitrosamine contamination.

Examination of the Process

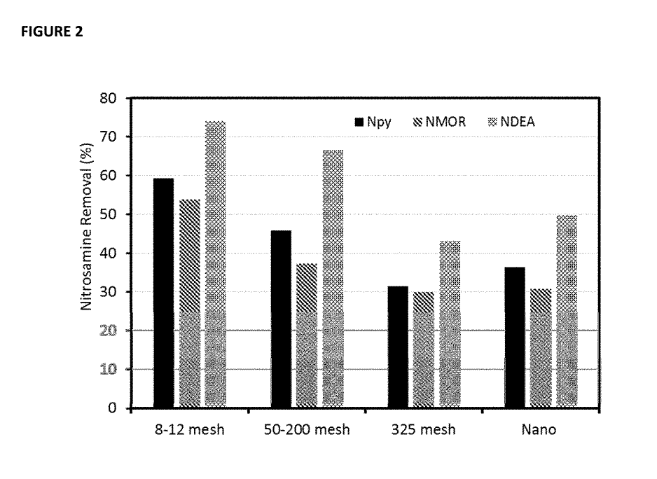

This removal technology demonstrates efficient absorption, with high capacity and selectivity for nitrosamines. Efficient adsorption of nitrosamines by different types of activated carbon is demonstrated in highly concentrated solutions (>1000 ppm) of three different commercially available nitrosamines, with 1 wt % carbon for 24 hours. Nitrosopyrrolidine (NPy) is the most cost effective and least toxic commercially available nitrosamine, so it is used as a surrogate to demonstrate the removal of compounds such as nitrosomorpholine (NMOR) and nitrosodiethylamine (NDEA), which are nitrosamines derived from common solvents and have been detected in CCS systems. As can be seen in FIG. 2, the largest particle size, 8-12 mesh coconut charcoal activated carbon shows the best performance for the removal of multiple nitrosamines from solution. This larger mesh size is also advantageous for a flow-through system where pressure drop is an important consideration.

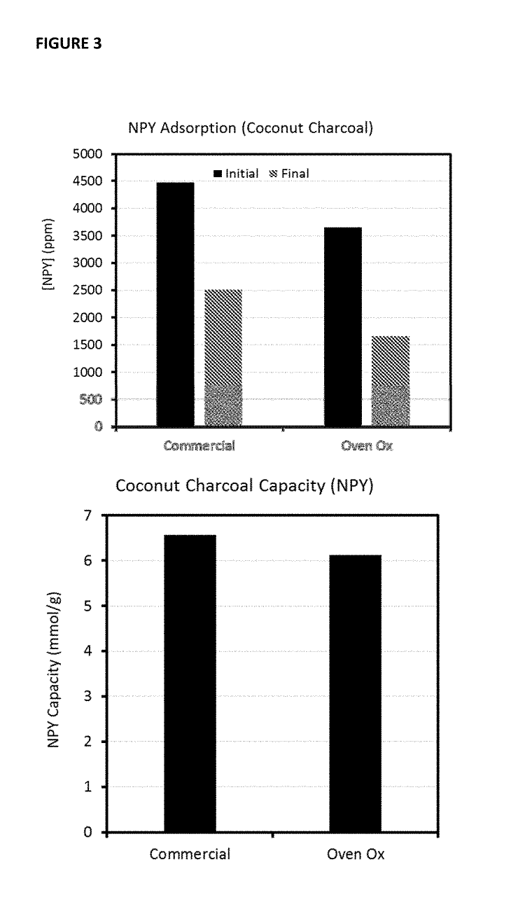

The high capacity of absorption was determined using a circulating batch-mode apparatus, where a sample of nitrosamine-containing solution was circulated through the carbon bed continuously for several hours. The nitrosamine solution is far more concentrated than would ever be present in a process in order to determine the saturation point and allow for facile analysis of the residual nitrosamine left in solution. This study was conducted with coconut charcoal carbon, as well as a sample where the carbon was pre-oxidized to impart increased oxygen functionalization on the surface, simulating carbon degradation that may happen in the industrially-relevant process. As can be seen in FIG. 3, there is significant nitrosamine adsorption observed for both carbon samples, with similar maximum loadings between 6-6.5 nm 10 l/g of nitrosopyrrolidine. This translates to approximately 600-650 mg of nitrosamine adsorbed per 1 g of carbon. No significant impact of surface oxidation at 300 DC is observed, indicating that thermal nitrosamine destruction is a viable method for carbon recycling. In addition, the data in FIG. 3 shows there is no impact on nitrosamine adsorption upon the addition of up to 0.3 wt. % amine (mono ethanolamine, MEA), which is known to accumulate in the waterwash section. This selectivity for adsorption of nitrosamine over alkanolamines is a key factor in the ability of the activated carbon bed to effectively remove nitrosamines under industrially-relevant conditions.

This nitrosamine removal technology is applicable to any large stationary sources where the production of nitrosamines is a concern, including electric power stations, chemical industries, post-combustion CO₂ capture with aqueous amine processes, and municipal water treatment.

The advantage of this nitrosamine removal technology is its straightforwardness, efficiency, cost effectiveness, and ease of use and disposal of materials over other nitrosamine mitigation strategies performed with expensive reagents, catalysts, and membranes. Further, the set-up to establish a circulation of the wastewater from waterwash section to the sorbent bed is sufficiently flexible that it can be readily retrofitted to any existing CCS.

### EXAMPLES

### Example 1

Nitrosamines generated in the amine solvent loop of post combustion carbon capture systems are potent carcinogens, and their emission could pose a serious threat to the environment or human health. Nitrosamine emission control strategies are critical for the success of amine-based carbon capture as the technology approaches industrial-scale deployment. Waterwash systems have been used to control volatile and aerosol emissions, including nitrosamines, from carbon capture plants, but it is still necessary to remove or destroy nitrosamines in the circulating waterwash to prevent their subsequent emissions into the environment. In this study, a cost-effective method for selectively removing nitrosamines from the absorber waterwash effluent with activated carbon sorbents was developed to reduce the environmental impact associated with amine-based carbon capture. The results show that the commercial activated carbon sorbents tested have a high capacity and selectively for nitrosamines over the parent solvent amines, with capacities up to 190 mg/g carbon, under simulated amine waterwash conditions. To further reduce costs, an aerobic thermal sorbent regeneration step was also examined due to the low thermal stability of nitrosamines. To model the effect of oxidation on the sorbent performance, thermal and acid oxidized sorbents were also prepared from the commercial sorbents and analyzed. The chemical and physical properties of nitrosamines, the parent amine, and the influence of the physical properties of the carbon sorbents on nitrosamine adsorption was examined. Key sorbent properties included the sorbent hydrophilicity/hydrophobicity, surface pKa of the sorbent, and 30 chemical structure of the parent amine and nitrosamine.

### Introduction

Significant challenges exist in controlling the emissions of the amine solvents and amine degradation products from post-combustion carbon capture systems (CCS). CCS amine emissions increase solvent makeup rates and can release hazardous compounds, such as carcinogenic nitrosamines, into the environment (Badr et al., Int. J. Greenhouse Gas Control 2017, 56, 202-220). Nitrosamines can form from the reaction of NOx in coal combustion flue gas with secondary amines, either as the principle amine used as the CO2 capture solvent, or from degradation of primary or tertiary amines that yield secondary amine products which can accumulate in the amine solvent loop and waterwash sections (Reynolds et al., Environ. Sci. Technol. 2012, 46 (7), 3643-54; Magee et al., Br. J. Cancer 1956, 10 (1), 114-22; Dai et al., Environ. Sci. Technol. 2015, 49 (14), 8878-8886; Dai et al., Environ. Sci. Technol. 2012, 46 (17), 9793-801; da Silva et al., Energy Procedia 2013, 37, 784-790; Goldman et al., Environ. Sci. Technol. 2013, 47 (7), 3528-34; Dai et al., Environ. Sci. Technol. 2014, 48 (13), 7519-26; de Koeijer et al., Int. J. Greenhouse Gas Control 2013, 18, 200-207; Yu et al., Ind. Eng. Chem. Res. 2016, 55 (9), 2604-2614).

First identified as carcinogens in the 1950s, 3 nitrosamines have been studied extensively and show both carcinogenic and mutanogenic effects in animals (Straif et al., Occup. Environ. Med. 2000, 57 (3), 180-7; Agency for Toxic Substances and Disease Registry (ATSDR). ToxFAQs—N-nitrosodimethylamine 1999). The US-EPA has classified nitrosamines as priority toxic pollutants on the Code of Federal Regulations (40 CFR 131.36) and the International Agency for Research on Cancer have listed nitrosamines as likely human carcinogens (Agency for Toxic Substances and Disease Registry (ATSDR). ToxFAQs—N-nitrosodimethylamine 1999; International Agency for Research on Cancer. Some N-nitroso compounds. IARC 1978, Lyon). Nitrosamines are not only generated in amine-based carbon capture systems, but are also found in food products, cosmetics, tobacco, and are detected in waste water treatment processes (Izquierdo-Pulido et al., Food Chem. Toxicol. 1996, 34 (3), 297-9; Levallois et al., Food Chem Toxicol 2000, 38 (11), 1013-9; Altkofer et al., Mol. Nutr. Food Res. 2005, 49 (3), 235-8; Chon et al., Bioresource Technology 2015, 190, 499-507). Several states have implemented nitrosamine limits for drinking water including California (3 ng/L) and Massachusetts (10 ng/L) (California Environmental Protection Agency (Cal/EPA). Office of Environmental Health Hazard assessment. Public Health Goals for Chemicals in Drinking Water—N-nitrosodimethylamine. 2006; Massachusetts Department of Environmental Protection (Mass DEP). Current regulatory limit: n-Nitrosodimethylamine. 2004). The US EPA has also made recommendations to limit environmental nitrosamine levels in lakes and streams (NDMA 0.69 ng/L) to prevent contaminated drinking water or fish from impacting public health.

The first report of nitrosamines in amine-based carbon capture is from Strazisar and coworkers, where a total nitrosamine concentration of 2.91 μmol/mL was identified in a lean MEA solvent (Strazisar et al., Energy Fuels 2003, 17 (4), 1034-1039). Since then, there has been significant effort to understand the source and properties of nitrosamines found in amine solvents and waterwash sections of CCS systems. Voice, Dai, and others have identified a variety of nitrosamines in simulated and pilot plant studies from solvents including MEA, PZ, and AMP (Voice et al., Int. J. Greenhouse Gas Control 2015, 39, 329-334; Dai et al., Environ. Sci. Technol. 2012, 46 (17), 9793-801; Review of Amine Emissions from Carbon Capture Systems, Version 2.01. Scottish Environment Protection Agency, 2015). The concentration of nitrosamines in CCS systems can vary greatly, depending on the solvent, operating conditions, and where in the process samples are collected. For example, Dai and coworkers identified 6.7 μM of nitrosamines in a MEA solvent and 1063 μM in a AMP/PZ solvent blend (Dai et al., Environ Sci Technol., 2012 9793-801). Nitrosamines were also identified at 56 μM in the waterwash section, at the top of the absorber, in the same AMP/PZ testing campaign.

The Norwegian Institute of Public Health (NIPH) initially proposed an emission limit of 0.3 ng/m³, for combined nitrosamines and nitramines, in the environmental permit for the carbon capture Technology Centre Mongstad as their impact assessments warn of the potential environmental hazards from nitrosamine emissions at amine-based carbon capture systems (Karl et al., Int. J. Greenhouse Gas Control 2011, 5 (3), 439-447; Norwegian Climate and Pollution Agency. Permit for activities pursuant to the Pollution Control Act. CO2 Technology Centre. Mongstad D A; 1; 2011). In order to reduce the potential environmental and health impact, significant effort has been made towards the prevention or destruction of nitrosamines for a variety of applications.

Nitrite scavenging has been examined to reduce nitrosamine formation in amine solvents. Previous work from our group showed that nitrite scavengers are effective at inhibiting the formation of nitrosomorpholine from morpholine by removing the key nitrite reactant after it is formed from NOx dissolving in the amine solvent (Chandan et al., Int. J. Greenhouse Gas Control 2014, 31, 61-66). Several other additives, including ascorbic acid and cysteine, can be reasonably effective at reducing the formation of MNPZ in a PZ/AMP solvent.

Destroying nitrosamines after they have formed is another mitigation strategy that has been explored. Sørensen et al. reported on the photodegradation of nitrosamines in natural waters environments similar to those expected in areas surrounding power plants with CO2 capture systems using aqueous amines (Sørensen et al., Int. J. Greenhouse Gas Control 2015, 32, 106-114). Under these conditions, nitrosamine can be expected to degrade when exposed to direct sunlight within 20 minutes to 2 hours, at summer and winter type environmental conditions, respectively. This study did note that photodegradation of nitrosamine would only occur during daylight hours, while nitrosamines emitted at night have the potential to persist in the environment.

In lab scale UV irradiation experiments, nitrosamine half-lives ranged from 4-8 minutes under batch reactor conditions (Afzal et al., Int. J. Greenhouse Gas Control 2016, 52, 44-51). The decomposition of the nitrosamines by UV irradiation occurred through N—N bond cleavage, which was confirmed by monitoring formation of nitrate/nitrite in the solvent. A similar study also showed that nitrosamines (NDMA and NDELA) can be decomposed using UV irradiation in both waterwash solutions and concentrated amine solvents, such as 30% MEA and 50% DEA (Knuutila et al., Int. J. Greenhouse Gas Control 2014, 31, 182-191). Formation of nitrite/nitrate was also observed in these batch scale experiments, further confirming the proposed UV degradation route of N—N bond cleavage. Nitrosamine decomposition by UV irradiation was significantly more efficient in a simulated waterwash solution than in the fresh concentration amine solutions (33 times slower) due to competitive degradation of the amine over the nitrosamine.

Using a combination of UV and UV plus ozone to decompose nitrosamines from CO2 capture waterwash solutions was studied, but the effectiveness of the UV+ozone treatment was impacted by ozonation byproducts formed by decomposition of residual amine as it competed for photons and reduced the impact of the UV.4 Overall, the ozone treatment reduced the formation of nitrosamines in the waterwash, but since this method also decomposed amines it may only be applicable with multi-stage waterwashes in the 2nd or 3rd stage to minimize amine destruction. In contrast to these results, Fujioka et al. showed that ozonation can actually lead to an increase in nitrosamine formation at certain ozone doses (Fujioka et al., Ozone: Science & Engineering 2014, 36 (2), 174-180). Other reports, including from Chuang et al., showed that ozonation, combined with biofiltration (nitrified growth on activated carbon) was able to reduce NDMA concentration formed during wastewater treatment (chloramination) relative to an untreated sample (Chuang et al., Environ. Sci. Technol. 2017, 51 (4), 2329-2338). Nitrosamines can be effectively mitigated from wastewater by filtering with biological activated carbon and activated sludge and using high dose UV combined with reverse osmosis filtration, although the later approach is not favored due to it relatively high cost to remove the low concentration nitrosamine pollutants (Gerrity et al., Water Research 2015, 72, 251-261).

The catalytic reduction of nitrosamines back to their parent amines (amine recovery) has been reported using palladium, nickel and iron based redox metal catalysts. In the study by Chandan et al., the Ni based catalyst showed excellent activity (>95%) toward the destruction of 100 mg/L nitrosopyrrolidine in 5 mol/kg MEA solution at 120 psi hydrogen pressure and 120° C. temperature in 4 hours (Chandan et al., Int. J. Greenhouse Gas Control 2015, 39, 158-165). Fly ash was also shown to have some activity towards catalytic nitrosamine reduction with H2 (Chandan et al., Energy Procedia 2014, 63, 808-813). The catalytic destruction of nitrosamines from tobacco smoke using crystalline aluminosilicate zeolites has also been reported (Li et al., Environmental Chemistry Letters 2014, 12 (1), 139-152).

Thermal decomposition of nitrosamines directly in amine solvents was reported using a batch reactor and cycling system and showed that the thermal degradation of mono-nitrosopiperazine (MNPZ) at 150° C. could be fitted with a first order rate law on the order of several days. 21 The thermal decomposition of NDELA, NHEGly (nitroso-2(hydroxyethyl) glycine) and MNPZ in a batch reactors at 150° C. was also reported (Fine et al., Environ. Sci. Technol. 2014, 48 (10), 5996-6002). The nitrosamine thermal decomposition rate showed a dependence to base strength, with higher pH leading to higher decomposition rates. While this approach may be effective in treating concentrated amine solutions, such as in a thermal reclaimer, treating a waterwash solution in the same manner may be slower and less effective due to the lower nitrosamine concentration and lower pH of waterwash solutions. Nielsen et al. also showed the thermal degradation of NPZ and formation of NPZ in the absorber yielded a steady state concentration of near 1 mmol/kg (Nielsen et al., Energy Procedia 2013, 37, 1912-1923). In contrast to these reports, nitrosamine formation from morpholine is enhanced at higher temperatures up to 145° C. Therefore, the thermal degradation temperature may vary for a different of nitrosamines, and more research is likely necessary to tailor this approach for different solvents and solvent blends where different nitrosamines are expected to form.

Nitrosamines have been selectively adsorbed and separated from gases and solutions using aluminosilicate zeolites. The zeolite structure, specifically the pore size and surface hydrophobicity, can have a large impact on the adsorption of nitrosamines. A variety of adsorbent materials to remove tobacco specific nitrosamines from liquid solutions including zeolites, impregnated and calcinated activated carbon, acid impregnated activated carbon and ion-exchange modified activated carbon have also been studied (Sun et al., Microporous and Mesoporous Materials 2014, 200, 260-268).

While each of these nitrosamine mitigation methods has shown promise, the relative complexity and/or cost of these may be prohibitive on a large industrial CCS scale, requiring simpler and more cost effective approaches to be developed. There are widespread existing applications for activated carbon beds in various industries, and existing units can be adapted to accept a wide range of sorbent materials; including potable and wastewater treatment, decolorization of food products, air purification, automotive emission control, and solvent vapor recovery (Council, Disposal of Activated Carbon from Chemical Agent Disposal Facilities. The National Academies Press: Washington, D C, 2009; p 86). In this study, a novel cost-effective nitrosamine removal technology that can easily retrofit onto new or existing waterwash sections of carbon capture systems has been developed.

The vapor pressure of nitrosamines can lead to gas phase partitioning of these degradation products out of the amine solvent loop where they are subsequently captured and concentrated in a waterwash (Thompson et al., Presentation at the 13th International Conference on Greenhouse Gas Control Technologies (GHGT-13), 14-18 Nov. 2016, Lausanne, Switzerland). These waterwash emission control systems, located on top of the absorber, have been developed to reduce amine emissions by capturing mechanical emissions (entrainment) into a separate water circulation loop (Thitakamol et al., Int. J. Greenhouse 579 Gas Control 2007, 1 (3), 318-342; Veltman et al., Environ. Sci. Technol. 2010, 44 (4), 1496-502). However, the removal/destruction of nitrosamines at this point is still critical in order to prevent the subsequent concentration and re-emission of the nitrosamines into the environment. The lower concentration of solvent amine in the waterwash section, as opposed to the solvent loop, makes the waterwash location a better location for the selective removal of the relative low concentration nitrosamine contaminants.

Regeneration and reuse of the carbon sorbent can also be utilized to extend sorbent lifetime and keep the cost of this type of system low. Typical carbon regeneration is done under inert atmosphere at temperatures between 700-1000° C. while some nitrosamines can be decomposed at much lower temperatures, ex. NPZ at 150° C. (Sheintuch et al., Catalysis Today 1999, 53 (1), 73-80). Therefore, in order to keep material costs and handling low, a thermal regeneration step could be applied at lower temperatures and in air, further reducing cost. In a commercial sized system, the carbon sorbent bed will be designed to receive a continuous slip of the waterwash solution to maintain low levels of nitrosamines in the washing water and prevent partitioning into the vapor phase and emitting from the CCS. As part of this study, both of the commercial activated carbon sorbents were thermally oxidized, characterized, and tested for nitrosamine adsorption and selectivity, as a model for how these sorbents might preform after aerobic thermal regeneration. In addition, an acid treated sorbent was also characterized and tested as an extreme scenario to maximize differences in surface functionalization.

### Materials and Methods

### Circulating Sorbent Bed Apparatus

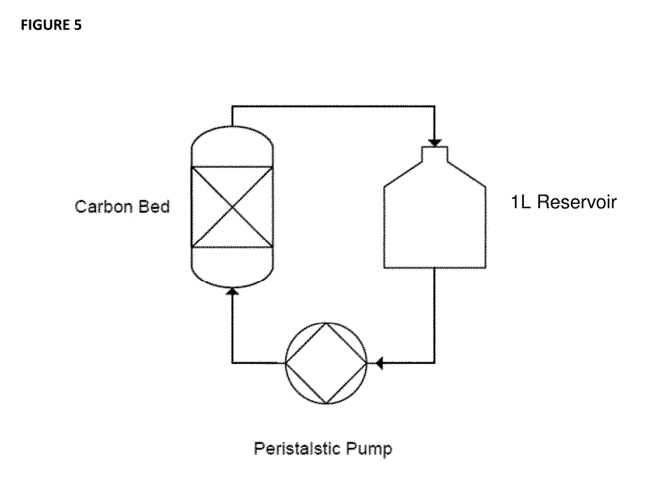

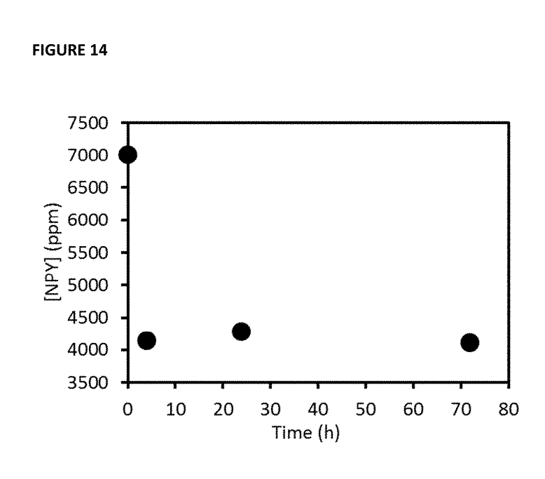

Adsorption of nitrosamines by the sorbents was evaluated in a circulating bed apparatus (FIG. 5). The experimental apparatus consists of a peristaltic pump, a 1 L reservoir and a packed bed of the sorbent materials. Adsorption experiments were performed with 500 mL of solution cycled through approximately 5 g of sorbent at a flow rate of 50 mL/min for 4 hours to ensure the carbon bed had reached equilibrium (FIG. 14). A sample of the solution was collected at the beginning and end of each experiment to measure the baseline and final nitrosamine concentrations, with total adsorption determined by the difference. The activated carbon sorbent was pre-wetted before each experiment. The relative size of the apparatus was selected to minimize the amount of nitrosamine used in these experiments while still producing scalable adsorption results.

### Carbon Bed 1 L Reservoir Peristalstic Pump

Commercial activated carbon (8-30 mesh, Calgon Carbon Corporation) and coconut charcoal activated carbon (8-12 mesh; Aqua Solutions Inc.) were selected for their widespread availability, low cost, and large particle size (lower pressure drop inside a packed sorbent bed). From these commercial carbons, a series of surface-modified sorbents were produced by subjecting the commercial material to thermal oxidation in air, and an acid treatment with HNO3. Thermal oxidation was performed by exposing the carbon material to 300° C. for 72 hours under ambient air conditions. The acid treated carbon sorbent was produced by refluxing with concentrated nitric acid (69%, VWR) for 24 hours, followed by thoroughly washing with water to remove any residual acid from the material. The pH of representative simulated waterwash was samples was examined, and shown to be constant over the range of these experiments (see supporting information), and is therefore disregarded in the discussion of absorption behavior herein.

Nitrosamine Analyses.

An Agilent 1260 Infinity high-performance liquid chromatography (HPLC) coupled to a 6224 series time-of-flight mass spectrometer (TOF-MS) was used to measure the concentration of nitrosamines. The HPLC was equipped with a reverse phase Zorbax Eclipse Plus Phenyl-Hexyl column (3.0 mm×100 mm×3.5 μm). Two MS sources were used to analyze the nitrosamines in these experiments. Electrospray ionization (ESI) was used analyze the concentrations of nitrosopyrrolidine (NPY), nitrosopiperazine (NPZ), and nitrosodiethylamine (NDEA). Atmospheric pressure chemical ionization (APCI) was used to measure the concentration of nitrosodiethanolamine (NDELA). When analyzing with ESI, an isocratic mobile phase of 60:40 acetonitrile (ACN; LC/MS grade, VWR) and 0.01% formic acid (LC/MS grade, Fisher Scientific) in water (LC/MS grade, VWR) was used with a flow rate of 0.3 mL/min with a 5 μL injected volume. With APCI, a 50:50 mixture of ACN and 0.01% formic acid in water with a flow rate of 0.8 mL/min and a 10 μL injection volume. Reported values are from an average of 3 injections for each sample, with error bars determined as the percent standard deviation from the average peak area value from these injections. A calibration curve was established at the beginning of each analysis using neat nitrosamine standards including NPY (99%, Sigma Aldrich), NPZ (99%, Sigma Aldrich), NDEA (>99%, Sigma Aldrich) and NDELA (Toronto Research Chemicals, Inc). Simulated waterwash solutions were prepared with pure monoethanolamine (>99%, Alfa Aesar) and piperazine (PZ) (99%, Acros Organics).

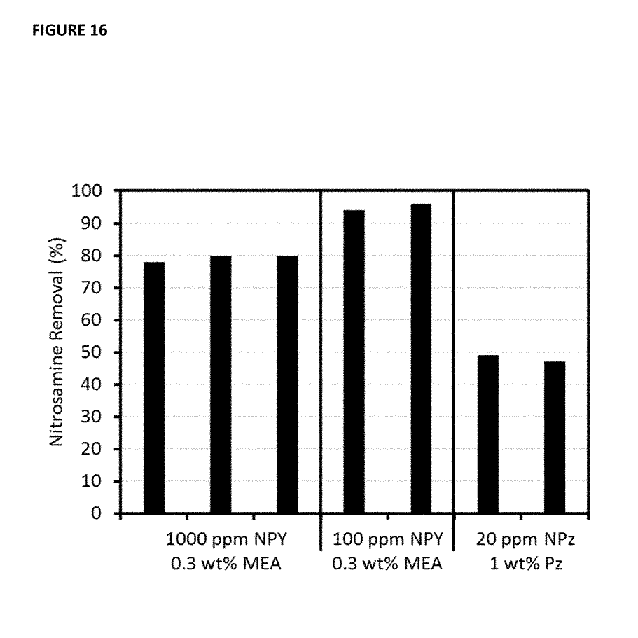

Due to the high cost and toxicity associated with the handling of concentrated nitrosamine solutions, replicate experiments were minimized where possible. Select representative nitrosamine absorption experiments were repeated and showed deviation <2% (see supporting information FIG. 16).

Material Characterization.

Scanning electron microscopy (SEM) and energy dispersive spectroscopy (EDS) was collected on a Hitachi S-4800 field-emission scanning electron microscope with a voltage of 15 kV and a current of 20 μA. Brunauer-Emmett-Teller (BET) N2 adsorption/desorption isotherms were measured using an ASAP2020 surface area and porosity analyzer (Micromeritics) with 50 mg of sample degassed at 160° C. for 12 hours. Cumulative pore volume was calculated via the non-localized density functional theory (NLDFT) provided by Micromeritics.

Surface pKa of the activated carbon was determined using a method adapted from Schwarz.43 In a typical experiment, 500 mg of carbon material was placed in a glass vial with 20 mL of degassed DI water, sealed and stirred for 48 hours. The pH of the resulting solution was then measured. The surface pKa measurements of each carbon was performed in triplicate.

Boehm titrations were performed to quantify acid and base sites on the surface of the commercial and modified carbon sorbents using a method adapted from Schwarz (Noh et al., Carbon 1990, 28 (5), 675-682). In a typical procedure, 200 mg of the carbon sorbent was placed into a sealed vial with 20.0 mL of standardized 0.02 M HCl or 0.02 M NaOH. After stirring for 48 h, the solution was filtered and back titrated using phenolphthalein as an indicator with standardized 0.02 M NaOH (to measure base sites) or 0.02 M HCl (to measure acid sites). The total adsorbed moles of acid/base were then determined as mmol of acid/base per gram of carbon material. Each carbon was analyzed in duplicate and each titration was performed in triplicate.

Thermal Regeneration.

In order to test the possibility of regenerating the sorbents, two samples of commercial coconut charcoal activated carbon were pre-saturated by exposure to a 1000 ppm NPY solution for 4 hr. The sorbent was removed and placed in a 200° C. oven for 20 h to decompose and remove the nitrosamine regenerate the sorbent. The carbon sorbents were then re-exposed to solutions containing a high concentration (1000 ppm) and low concentration (15 ppm) of NPY.

### Results and Discussion

Sorbent Characterization.

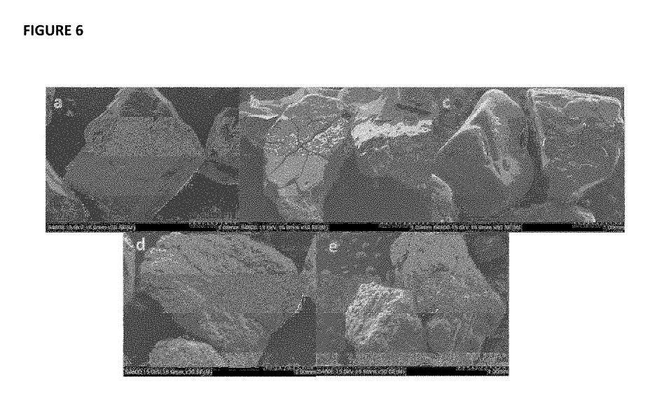

The physical and chemical properties of the commercial and oxidized carbon sorbents were characterized by SEM, EDS, BET, pH, and Boehm titration (Table 1). The SEM images in FIG. 6 show little noticeable qualitative change to the morphology of activated carbon samples upon thermal and acid treatment. Comparing the surface carbon and oxygen content for the sorbent series, Table 1 shows increased oxygen content and a lower corresponding carbon content, on the surface upon oxidation (see supporting information, Table 3, for full EDS results). Thermal treatment increases the oxygen content of coconut charcoal from 5.25 to 14.81%, while the activated carbon only increases from 6.75 to 8.16%. The acid treated coconut charcoal had the highest oxygen content, at 23.87%. The BET results also shows changes in the surface area and pore volume upon thermal and acid treatment of the coconut charcoal, but no change upon thermal treatment of the activated carbon. The surface area and pore volumes of the coconut charcoal increase upon thermal treatment and decrease with acid treatment, while the pore size remains constant over the series.

Examination of the chemical properties shows much larger variation over the series, although the activated carbon still shows less change than the coconut charcoal samples. There is an overall decrease in the observed surface pKa upon exposure of both commercial sorbents to the oxidative thermal, which is also reflected in the total acid/base sites from the Boehm titration data. The total acid sites increase while the base sites decrease upon treatment, although the effect is more dramatic in the coconut charcoal than the activated carbon.

TABLE 1
Characterization data for activated carbon sorbents tested

| | Carbon Type | | | | |
|---|---|---|---|---|---|
| | Commercial | Oxidized | | Commercial | Oxidized |
| | Coconut | Coconut | Acid Coconut | Activated | Activated |
| | Charcoal | Charcoal | Charcoal | Carbon | Carbon |
| | Surface Content (EDS) | | | | |
| Physical | C: 92.11 | C: 80.56 | C: 76.13 | C: 88.48 | C: 87.31 |
| Properties | O: 5.25 | O: 14.81 | O: 23.87 | O: 6.75 | O: 8.16 |
| Surface Area | 848 | 1010 | 660 | 988 | 982 |
| (m2/g) | | | | | |
| Pore Volume | 0.46 | 0.58 | 0.37 | 0.65 | 0.65 |
| (cm3/g) | | | | | |
| Pore Size | 2.18 | 2.29 | 2.23 | 2.64 | 2.63 |
| (nm) | | | | | |
| Surface | | | | | |
| pKa (±) | 10.54 (0.22) | 8.25 (0.38) | 3.26 (0.57) | 7.90 (0.69) | 6.74 (0.21) |
| Total Acid | 0.19 | 0.62 | 2.0 | 0.30 | 0.55 |
| Sites | | | | | |
| (mmol/g) | | | | | |
| Total Base | 0.51 | 0.41 | 0 | 0.27 | 0.20 |
| Sites | | | | | |
| (mmol/g) | | | | | |

Nitrosamine Adsorption Capacity and Behavior from a Simulated Waterwash.

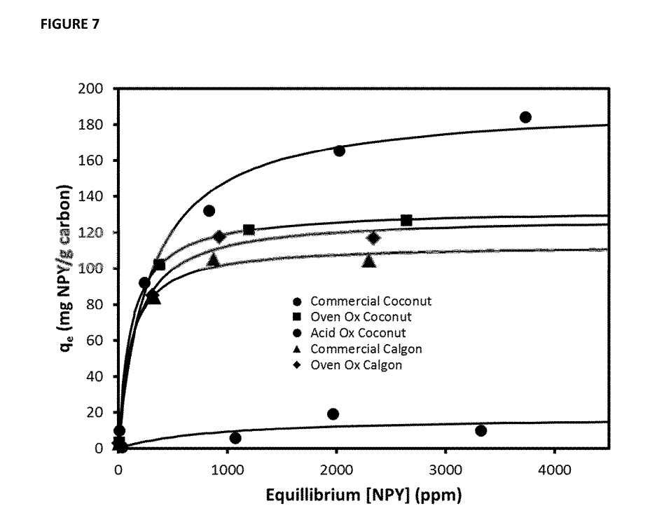

The maximum nitrosamine retention capacity and the adsorption behavior of the carbon sorbents was determined using a model nitrosamine (NPY) to construct adsorption isotherms in a simulated CO2 capture waterwash solution containing a low concentration of amine, in these experiments 0.3 wt % MEA, based on published reports from pilot waterwash systems (Carter, Presentation at the NETL CO2 Capture Technology Meeting, 9-12 Jul. 2012, Pittsburgh, Pa., USA; Morken et al., Energy Procedia 2014, 63, 6023-6038). A series of adsorption experiments were conducted where the initial NPY concentration was varied and the NPY capacity (qe, in mg NPY/g sorbent) was determined. The isotherm data for each sorbent was fitted to Langmuir and Freundlich adsorption models using equations (1) and (2) respectively, where qe is the equilibrium adsorption capacity, qm is the maximum adsorption capacity, kL/kF are the Langmuir and Freundlich constants, 1/n is an experimentally determined unit less exponent, and Ce is the equilibrium nitrosamine concentration (Li et al., Environ. Sci. Technol. 2010, 44 (22), 8692-8697; Li et al., Journal of Electroanalytical Chemistry 2011, 653 (1-2), 40-44.). The calculated Langmuir and Freundlich constants, as well as the error associated with these fits (χ²) are given in the supporting information (Table 4). All of the carbon sorbents exhibited Langmuir adsorption behavior (FIG. 7), and the maximum NPY capacity (qm) for each carbon sorbent is given in Table 2. The commercial coconut charcoal has the highest capacity at 191 mg NPY/g, with the oxidized coconut charcoal, commercial activated carbon and oxidized commercial activated carbon all showing reduced nitrosamine capacities between 105-121 mg NPY/g. The acid treated coconut charcoal shows the lowest capacity at 6 mg/g.

$$\begin{matrix}{q}_{e} = \frac{{q}_{m} {k}_{L} {C}_{e}}{1 + {k}_{L} {C}_{e}} Langmuir isotherm & ( 1 ) \\ {q}_{e} = {k}_{F} {C}_{e}^{1 / n} Freundlich isotherm & ( 2 )\end{matrix}$$

TABLE 2
Maximum NPY Capacity of Carbon Sorbents, as Calculated
from Langmuir Isotherm Fits

| | capacity, qm |
|---|---|
| carbon type | (mg NPY/g carbon) |
| commercial coconut | 191 |
| charcoal | |
| oxidized coconut | 121 |
| charcoal | |
| acid coconut charcoal | 6 |
| commercial activated | 105 |
| carbon | |
| oxidized activated | 117 |
| carbon | |

TABLE 3
Surface Composition of Carbon Sorbents by EDS

| | Commercial | Thermal | Acid | Commercial | Thermal |
|---|---|---|---|---|---|
| | Cocount | Cocount | Cocount | Activated | Activated |
| Element | Charcoal | Charcoal | Charcoal | Carbon | Carbon |
| C | 92.11 | 80.56 | 76.13 | 88.48 | 87.31 |
| O | 5.25 | 14.11 | 23.87 | 6.75 | 8.16 |
| Na | 0.25 | 0.27 | — | — | — |
| Mg | 0.26 | 0.24 | — | — | — |
| Al | — | — | — | 1.12 | 1.13 |
| Si | 0.58 | 0.33 | — | 2.21 | 2.08 |
| P | 0.25 | — | — | — | — |
| K | 1.31 | — | — | — | — |
| S | — | 0.34 | — | 0.87 | 0.87 |
| Fe | — | — | — | 0.56 | 0.45 |
| Cl | — | 0.20 | — | — | — |
| K | — | 2.85 | — | — | — |
| Ca | — | 0.40 | — | — | — |

TABLE 4
Calculated parameters and error from Langmuir and Freundlich isotherms

| | Langmuir | | | Freundlich | | |
|---|---|---|---|---|---|---|
| carbon type | qₘ | kₗ | χ² | n | k_{F} | χ² |
| commercial coconut | 191.43 | 0.0035 | 5.35 | 3.41 | 17.27 | 36.90 |
| charcoal | | | | | | |
| oxidized coconut | 132.75 | 0.0094 | 2.07 | 3.80 | 17.57 | 164.90 |
| charcoal | | | | | | |
| acid coconut | 17.49 | 0.0011 | 6.58 | 2.46 | 0.52 | 9.67 |
| charcoal | | | | | | |
| commercial activated | 113.19 | 0.0094 | 2.07 | 3.79 | 15.47 | 157.83 |
| carbon | | | | | | |
| oxidized activated | 128.64 | 0.0069 | 0.63 | 3.77 | 16.71 | 131.80 |
| carbon | | | | | | |

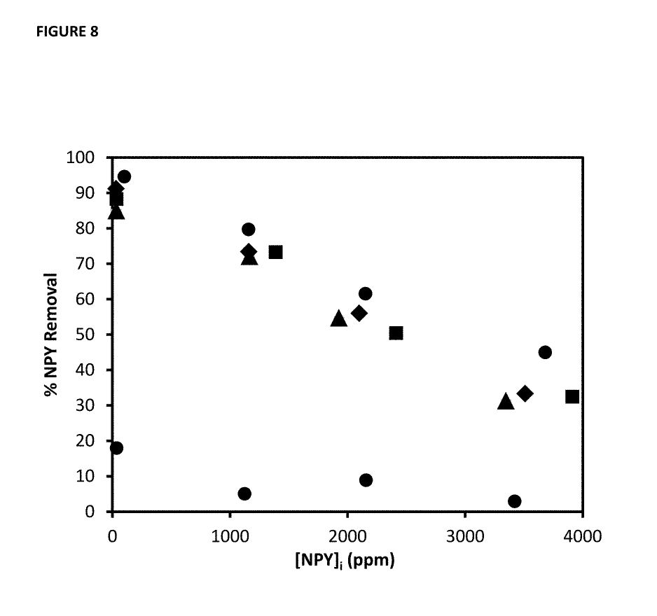

The adsorption of NPY from solution initially increases dramatically at higher NPY concentrations, but levels off at a maximum, as shown in FIG. 7 (Li et al., Environ. Sci. Technol. 2010, 44 (22), 8692-8697). However, when the adsorption capacity is converted to removal efficiency (% NPY removal, FIG. 8), it is apparent that better adsorption is obtained at lower concentrations. Although the data in FIG. 8 is from batch mode experiments with a fixed initial NPY concentration, this type of behavior will likely be is advantageous for CO2 capture applications where nitrosamines, after forming in the absorber, are captured and accumulate in the wash-water section at relatively low concentrations. With constant treatment through a sorbent, efficient nitrosamine removal can keep concentrations relatively low preventing re-emission into the environment in the scrubbed flue gas from the waterwash based on their Henry's volatility coefficient.

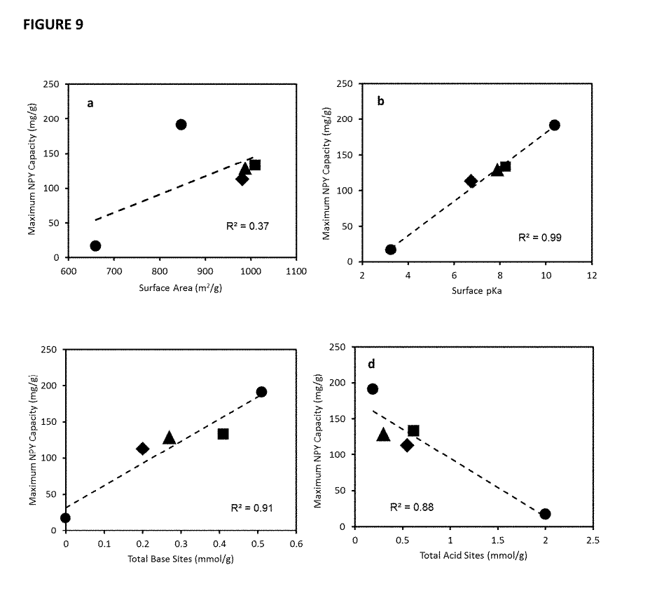

In this study we did not find a correlation between the physical properties of the sorbent, such as surface area, and NPY capacity (FIG. 9a). Instead, FIG. 9b shows a close linear relationship (R2>0.99) between the surface pKa and NPY adsorption, where the more basic carbon surfaces exhibit higher capacity for NPY. The relationship for total acid/base versus NPY capacity is less linear, but there is still a clear trend (FIG. 9c) showing base sites favor nitrosamine adsorption, while acid sites decrease adsorption (FIG. 9d).

Amine Adsorption & Nitrosamine Selectivity.

When applied to a commercial CCS process, it will be critical that the sorbent selectively remove nitrosamines from the circulating waterwash while leaving the amine to be returned to the solvent loop during blowdown. This will serve to; (1) extend the lifetime of the carbon bed, as amine concentrations in the waterwash will be higher than that of nitrosamines; and (2) allow recovery of amine emissions and lower total amine losses and reduce operational costs.

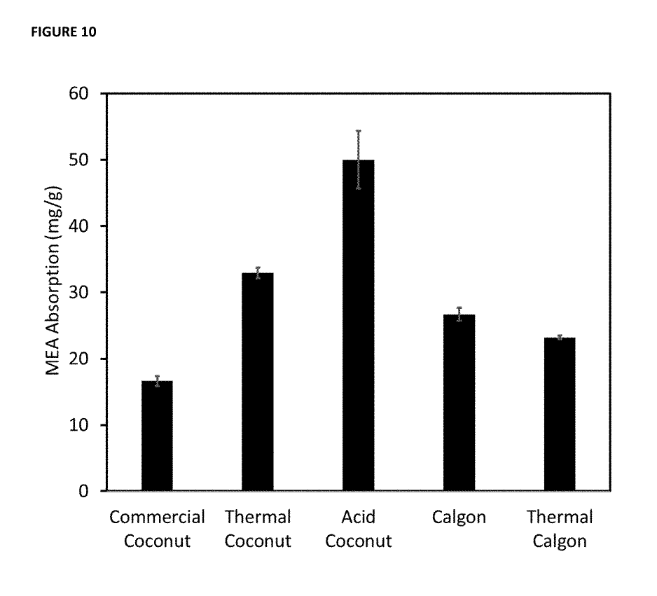

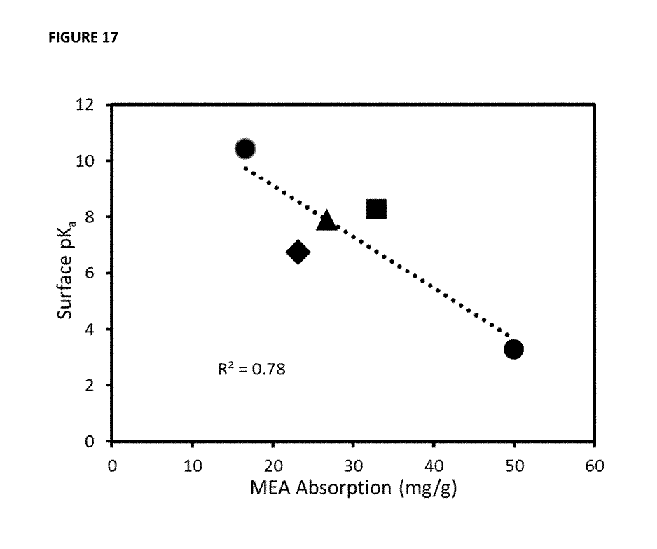

The affinity of each sorbent for amines was examined by circulating the simulated waterwash solution containing 0.3 wt % MEA, with no nitrosamines, through the same sorbent bed apparatus. The adsorption of the MEA by each sorbent was measured by difference. The affinity of the carbon sorbents for MEA varies widely (FIG. 10), with the coconut charcoal showing the lowest adsorption, and the acid treated coconut charcoal having the highest adsorption of MEA. There is a general trend between surface pKa and amine adsorption (see supporting information FIG. 17. In this case, the acid treated sorbent (with the lowest surface pKa) showed the highest absorbance of MEA, in contrast to nitrosamine adsorption.

While the coconut charcoal has the lowest adsorption of amine, and the highest adsorption of nitrosamines, the total impact of the amines presence in the simulated waterwash solution with regards to nitrosamine adsorption is not yet fully investigated. To this end, the effect of amine (MEA and PZ) in the waterwash solution on the selectivity of nitrosamine adsorption was determined using N-nitrosopyrrolidine (NPY) and N-nitrosopiperazine (NPZ) as representative nitrosamines. The percent nitrosamine removal from both the commercial coconut charcoal and oxidized coconut carbon sorbents was determined from pure water (no added MEA or PZ), and then from simulated waterwash solution (0.3 wt. % MEA, 1 wt. % PZ) based on reported waterwash amine concentrations (Cousins et al., Int. J. Greenhouse Gas Control 2015, 37, 256-263).

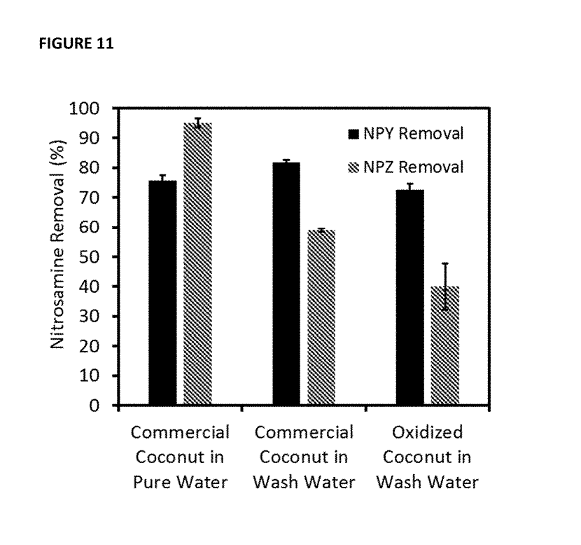

The results in FIG. 11 shows that the addition of MEA has no effect on NPY adsorption, indicating that although there is the possibility for MEA adsorption by the carbon sorbent, the selectivity of the coconut charcoal and oxidized coconut sorbent for nitrosamines over amines is likely sufficient to maintain nitrosamine adsorption capacity under these conditions. However, there is a decrease in the removal efficiency of NPZ upon the addition of 1 wt. % PZ to the matrix, indicating lower selectivity for NPZ over PZ. The higher concentration of PZ in the simulated waterwash may be a factor in the lower selectivity. Additionally, the similar structures of PZ and NPZ, varying by only the -nitroso group, may lower the ability of the sorbent to “discriminate” between the two compounds and decrease selectivity if adsorption is based on the structure/polarity of the components in solution. This then raises the question of how the sorbent system would perform at removing other process-relevant nitrosamines that result from the nitrosation of secondary-amine degradation products from a primary amine solvent such as MEA.

Degradation-Relevant Nitrosamine Adsorption.

The use of NPY as a representative nitrosamine is advantageous for initial studies due to its commercial availability and low cost, however testing the adsorption of process-relevant nitrosamines, those that are formed and have been detected in CCS systems, is also prudent. NDEA and NDELA have been reported as potential contaminants from the degradation and nitrosation of amine degradation products (Shah et al., Environ. Sci. Technol. 2013, 47 (6), 2799-808). While these two nitrosamines have a similar base structure, there is a dramatic difference in polarity due to the alcohol groups on NDELA.

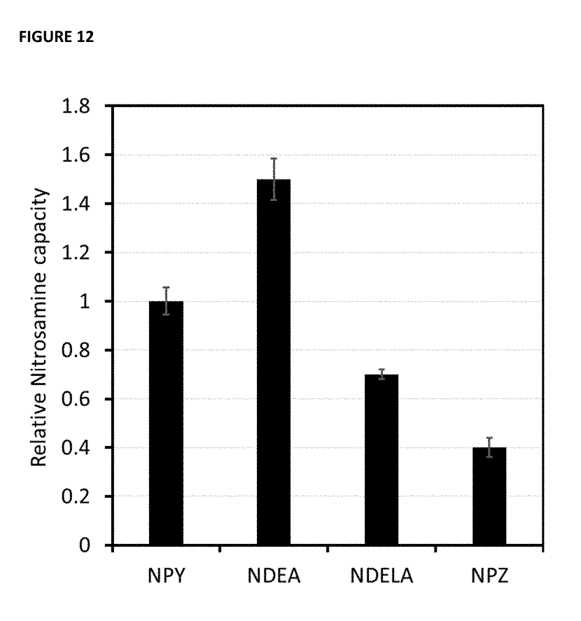

The difference in activity of the commercial coconut charcoal towards the removal of these two different nitrosamines was evaluated at a single concentration and compared to the calculated NPY adsorption from the Langumir curve with commercial coconut charcoal (vide supra). FIG. 12 shows the adsorption of NDEA, NDELA, and NPZ relative to NPY at the same concentration. NDEA, with a linear alkyl chain, has 50% higher adsorption than the slightly more polar, cyclic NPY. The more polar NDELA, with two alcohol groups, showed a 30% decrease in adsorption from the same solution with the same carbon sorbent. This indicates that surface pKa may not be the only contributing factor to nitrosamine adsorption by these sorbents, and in this case the polarity of the nitrosamine may also play a role in the observed adsorption differences. Again, NPZ adsorption may be reduced due to the higher amine concentration used in the simulated waterwash. The relative hydrophobicity/hydrophilicity of the carbon surface also appears to influence the affinity of the nitrosamine for the carbon surface. This suggests that in order to optimize adsorption, the hydrophobicity/hydrophilicity (polarity) of the sorbent surface may need to be matched to the nitrosamine(s) expected to form in the solvent either directly, or from amine degradation products.

Thermal Regeneration of Carbon Sorbent.

In order to extend the lifetime of the carbon sorbent and further decrease the potential long-term operating cost of the CCS system, the possibility of thermally regenerating the carbon sorbent was investigated. Typical regeneration of activated carbon is accomplished at elevated temperatures (700-1000° C.) under inert atmosphere to prevent surface oxidation.42 The thermal decomposition of some nitrosamines, including NPZ and NDELA, has been reported at temperatures as low as 100-150° C. in industrially-relevant amine solutions. In addition, Fine and coworkers showed that the rate of thermal nitrosamine decomposition is strongly dependent on the pKa of bases that are present in solution, such as parent amines, where a more basic amine solvent increases the nitrosamine decomposition rate. Information relating to the decomposition of other nitrosamines is not readily available in the open literature, but other nitrosamines are expected to have similar decomposition temperatures under similar conditions. Given this information, the possibility exists of regenerating the carbon sorbent at relatively low temperatures, which in turn would save on the cost of the regeneration and preclude the need for an inert atmosphere. In addition, the selection of a more basic sorbent to favor nitrosamine adsorption would also aid in nitrosamine destruction during a thermal regeneration cycle.

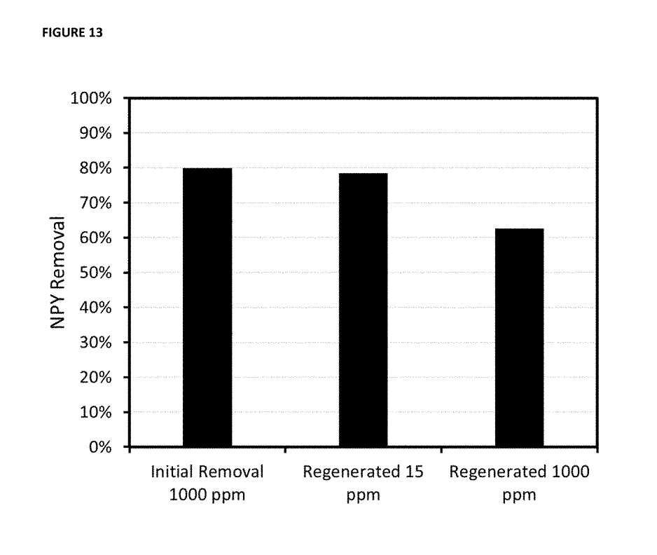

To further demonstrate this concept, a sample of coconut charcoal that had been exposed to a 1000 ppm solution of NPY in MEA waterwash was regenerated. Removal of NPY from a low concentration NPY solution (15 ppm) was un-affected when compared to the initial removal (FIG. 13), however there is a small decrease in removal efficiency (less than a 25%) when the sorbent was re-exposed to the high concentration solution (1000 ppm). This is consistent with previous results showing that better removal efficiency is achieved at lower nitrosamine concentrations. Although further work is needed to optimize the regeneration process itself, this initial result is promising in demonstrating that the carbon can potentially be regenerated and recycled under relatively mild conditions and can be used to maintain lower nitrosamine concentrations in the circulating waterwash solution.

Implications.

Activated carbons can be used as a solid sorbent for the selective removal of nitrosamine contaminants from simulated amine-based CCS waterwash conditions. Activated carbon is inexpensive, widely available, and familiar to the power industry as mercury removal sorbent. Furthermore, the application of a carbon bed for circulation and treatment of liquid is a well-known technology, and is currently used in CCS applications to removal degradation products for controlling forming in the absorber. There is a strong correlation between surface pKa and nitrosamine removal, where the more basic commercial coconut charcoal exhibited the highest nitrosamine capacity and the most acidic surface showed almost no activity, giving a direction for the development of further sorbent modifications to further increase adsorption capacity. Testing of different, industrially-relevant, nitrosamines under the same conditions showed that more hydrophobic nitrosamines have greater affinity for commercial coconut charcoal, indicating that matching the hydrophobicity/hydrophilicity of the carbon sorbent and expected nitrosamines may be a key feature of these systems moving forward. For applications with secondary amines, such as PZ/NPZ, it may be advantageous to develop a carbon sorbent functionalized with a more basic surface to increase adsorption. Regeneration of the carbon sorbent under mild conditions may also be possible for further cost savings. Further work is underway to quantify the hydrophobicity of the carbon sorbents, develop more effective surface functionalization, and characterize/optimize the thermal regeneration process.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled. All documents referenced herein including patents, patent applications and journal articles and hereby incorporated by reference in their entirety.

1. A method to capture nitrosamines from waterwash in a carbon capture system (CCS) comprising:
a. establishing an exit portal and an entrance portal to a waterwash chamber of the CCS and providing a circulation connection line between the exit and the entrance portal such that waterwash can flow;
b. placing a sorbent bed within the circulation connection line, wherein the sorbent bed comprises activated carbon; and
c. circulating waterwash from the waterwash section through the sorbent bed and back to the waterwash section to capture nitrosamines.

2. The method of claim 1, wherein activated carbon in the sorbent bed has an average surface area of between about 600 to 1200 m2/g.

3. The method of claim 1, wherein activated carbon in the sorbent bed has an average pore volume of between about 0.3 and 0.7 cm3/g.

4. The method of claim 1, wherein activated carbon in the sorbent bed has an average pore size of between about 2.0 and 3.0 nm.

5. The method of claim 1, wherein activated carbon in the sorbent bed has an average mesh size of between 8-10 to 8-30 mesh.

6. The method of claim 5, wherein the sorbent bed further comprises at least one screen to prevent activated carbon flowing from into the waterwash section.

7. The method of claim 1, wherein activated carbon in the sorbent bed has a surface pKa of between about 6.5 to 11.

8. The method of claim 1, wherein activated carbon in the sorbent bed further comprises surface oxygen such that surface content of carbon to oxygen is from about 95:5 to about 75:25.

9. The method of claim 7, wherein the activated carbon further comprises presence of at least one of chlorine, potassium, iron, sodium, aluminum, magnesium, phosphorus, iron, silicon, sulfur, calcium or mixtures thereof.

10. The method of claim 1, wherein activated carbon in the sorbent bed comprises oxidized activated carbon.

11. The method of claim 1, further comprising a pump connected to the circulation connection line to assist in circulating the waterwash.

12. The method of claim 1, further comprising a step of periodic regeneration of the sorbent bed, wherein regeneration comprises thermal treatment of activated carbon in the sorbent bed at between about 700 to 1000° C.

13. The method of claim 1, further comprising a step of periodically replacing the sorbent bed.

14. The method of claim 1, further comprising at least one valve to control the flow of waterwash to the sorbent bed.

15. A carbon capture system (CCS) comprising an absorber section, a stripper section, a waterwash section and a sorbent bed section, wherein the waterwash section is connected to the sorbent bed section such that water can circulate from the waterwash section to the sorbent bed section and return back to the waterwash section, and further wherein the sorbent bed section comprises activated carbon.
